(19) United States
(12) Patent Application Publication
(10) Pub. No.: US 2014/0002350 A1
(43) Pub. Date: Jan. 2, 2014

(54) ELECTRONIC DEVICE AND METHOD FOR PROCESSING AN OBJECT

(71) Applicant: LENOVO (BEIJING) LIMITED, Beijing (CN)

(72) Inventor: Zhiqiang Zhou, Beijing (CN)

(73) Assignee: LENOVO (BEIJING) LIMITED, Beijing (CN)

(21) Appl. No.: 13/923,066

(22) Filed: Jun. 20, 2013

(30) Foreign Application Priority Data
Jun. 29, 2012 (CN) 201210226823.7

(51) Int. Cl. G06F 3/01

(52) U.S. Cl. CPC G06F 3/01
USPC 345/156

(57) ABSTRACT

Electronic devices and methods for processing an object in an electronic device are provided. The method includes: when a sensor unit detects that an operator is holding the electronic device, obtaining a first holding position parameter of the operator relative to an input unit; determining a correspondence between the object and the input unit based on the first holding position parameter; and outputting the object by a display unit based on the correspondence. The electronic device includes a processing unit configured to, when a sensor unit detects that an operator is holding the electronic device, obtaining a first holding position parameter of the operator relative to an input unit, determine a correspondence between the object and the input unit based on the first holding position parameter, and output the object via a display unit based on the correspondence.

### TECHNICAL FIELD

The present invention relates to display technology, and more particularly, to electronic devices and methods for processing an object.

### BACKGROUND

With the rapid development of electronic devices such as mobile phones and computers, display screens of the electronic devices become larger and more colorful, and are thus capable of providing users with fantastic visual experiences. When using a conventional electronic device, a user can operate the electronic device via a physical keyboard and/or a touch screen. However, the display position of each operation item in an object displayed on the electronic device is fixed. For example, Chinese characters typed using input methods in mobile phones such as Lephone, iPhone and mobile phones available from HTC and Samsung are arranged in from left to right according to how frequent these characters are used.

There are at least the following problems with such conventional electronic device.

First, as the size of screens in electronic devices increases, and the display position of each operation item in an object on an electronic device is fixed, it is inconvenient for a user to operate the electronic on the touch screen with one hand.

Second, when the electronic device has a physical keyboard and the user operates the physical keyboard with one hand, it is also inconvenient for the user's operation with one hand, since the display position of each operation item in an object on an electronic device is fixed.

### SUMMARY

Embodiments of the present application provide an electronic device and a method for processing an object in the electronic device that can facilitate a user's operation of the electronic device with one hand, and improve the user's experience of using the electronic device.

According to an embodiment of the present application, a method for processing an object in an electronic device comprising a sensor unit, an input unit and a display unit, the method comprising:

obtaining a first holding position parameter of the operator relative to the input unit when the sensor unit detects that an operator is holding the electronic device;

determining a correspondence between the object and the input unit based on the first holding position parameter; and

outputting the object by the display unit based on the correspondence.

In an embodiment, the input unit comprises a touch sensitive unit, and the method further comprises:

obtaining the first holding position parameter of the operator relative to the touch sensitive unit, when the sensor unit detects that the operator is holding the electronic device;

determining a first arrangement parameter of the object as the correspondence between the object and the input unit based on the first holding position parameter, the first arrangement parameter indicating a positional relation between at least two operation items in the object; and

outputting the object by the display unit based on the first arrangement parameter.

In an embodiment, determining a first arrangement parameter of the object as the correspondence between the object and the input unit based on the first holding position parameter further comprises:

determining an order parameter for a priority of each of the operation items in the object based on a predetermined policy; and

determining a display position for each of the operation items on the display unit based on the order parameter and the first holding position parameter.

In an embodiment, determining the display position for each of the operation items on the display unit based on the order parameter and the first holding position parameter comprises:

determining a side of the display unit closest to the operator as a holding side based on the first holding position parameter; and

displaying the operation items in a descending order of their priorities from the holding side to an opposite side on the display unit based on the order parameter.

In an embodiment, the method further comprises, when the sensor unit detects that an operator is holding the electronic device:

obtaining the object displayed on the display unit before obtaining the first holding position parameter;

obtaining the first holding position parameter of the operator relative to the input unit when the sensor unit detects that the operator is holding the electronic device;

determining the first arrangement parameter of the object based on the first holding position parameter; and

outputting the object by the display unit based on the first arrangement parameter.

In an embodiment, determining a first arrangement parameter of the object as the correspondence between the object and the input unit based on the first holding position parameter further comprises:

obtaining an operation instruction from the operator while obtaining the first holding position parameter;

obtaining an object associated with the operation instruction based on the operation instruction;

determining the first arrangement parameter of the object based on the first holding position parameter; and

outputting the object by the display unit based on the first arrangement parameter.

In an embodiment, the input unit comprises M physical input subunits, and the method further comprises:

obtaining the first holding position parameter of the operator relative to the input unit when the sensor unit detects that the operator is holding the electronic device;

determining a correspondence parameter indicating a correspondence between operation items in the object and the M physical input subunits as the correspondence between the object and the input unit based on the first holding position parameter; and

operating each of the operation item via a corresponding one of the physical input subunits based on the correspondence parameter.

In an embodiment, the method further comprises, after determining the correspondence parameter indicating a correspondence between operation items in the object and the M physical input subunits as the correspondence between the object and the input unit based on the first holding position parameter:

obtaining a first display position for each of the operation items on the display unit;

determining a second display position for each of the operation items based on the first holding position parameter, the second display position being the same as or different from the first display position;

displaying each of the operation items at its second display position based on the correspondence parameter and the second display position, such that the operation item corresponds to its corresponding physical input subunits.

According to a further embodiment of the present invention, an electronic device comprises a sensor unit, an input unit and a display unit. The electronic device further comprises a processing unit configured to:

obtain a first holding position parameter of the operator relative to the input unit, when the sensor unit detects that an operator is holding the electronic device;

determine a correspondence between the object and the input unit based on the first holding position parameter; and

output the object via the display unit based on the correspondence.

In an embodiment, the input unit comprises a touch sensitive unit, and the processing unit is further configured to:

obtain the first holding position parameter of the operator relative to the touch sensitive unit when the sensor unit detects that the operator is holding the electronic device;

determine a first arrangement parameter of the object as the correspondence between the object and the input unit based on the first holding position parameter, the first arrangement parameter indicating a positional relation between at least two operation items in the object; and

output the object via the display unit based on the first arrangement parameter.

In an embodiment, the processing unit comprises an arrangement parameter obtaining unit configured to:

determine an order parameter for a priority of each of the operation items in the object based on a predetermined policy; and

determine a display position for each of the operation items on the display unit based on the order parameter and the first holding position parameter.

In an embodiment, the arrangement parameter obtaining unit comprises a display position obtaining subunit configured to:

determine a side of the display unit closest to the operator as a holding side based on the first holding position parameter; and

display the operation items in a descending order of their priorities from the holding side to an opposite side on the display unit based on the order parameter.

In an embodiment, when the sensor unit detects that an operator is holding the electronic device, the processing unit is further configured to:

obtain the object displayed on the display unit before obtaining the first holding position parameter;

obtain the first holding position parameter of the operator relative to the input unit when the sensor unit detects that the operator is holding the electronic device;

determine the first arrangement parameter of the object based on the first holding position parameter; and

output the object via the display unit based on the first arrangement parameter.

In an embodiment, the processing unit is further configured to: obtain an operation instruction from the operator upon obtaining the first holding position parameter;

obtain an object associated with the operation instruction based on the operation instruction;

determine the first arrangement parameter of the object based on the first holding position parameter; and

output the object via the display unit based on the first arrangement parameter.

In an embodiment, the input unit comprises M physical input subunits, and the processing unit is further configured to:

obtain the first holding position parameter of the operator relative to the input unit when the sensor unit detects that the operator is holding the electronic device;

determine a correspondence parameter indicating a correspondence between operation items in the object and the M physical input subunits as the correspondence between the object and the input unit based on the first holding position parameter; and

operate each of the operation items via a corresponding one of the physical input subunits based on the correspondence parameter.

In an embodiment the processing unit is further configured to, after determining the correspondence parameter indicating the correspondence between operation items in the object and the M physical input subunits as the correspondence between the object and the input unit based on the first holding position parameter,

obtain a first display position for each of the operation items on the display unit;

determine a second display position for each of the operation items based on the first holding position parameter, the second display position being the same as or different from the first display position;

display each of the operation items at its second display position based on the correspondence parameter and the second display position, such that the operation items corresponds to its corresponding physical input subunits.

One or more of the technical solutions according to the embodiments of the present application has at least the following technical effects or advantages.

First, according to the embodiments of the present invention, a first holding position parameter of the operator relative to the input unit is obtained, a correspondence between the object and the input unit is determined based on the first holding position parameter, and the object is output by the display unit based on the correspondence. In this way, the object can be changed as the first holding position parameter changes, and thus both the user experience and the user convenience can be improved.

Second, according to the embodiments of the present invention, when the input unit includes a touch sensitive unit, the first arrangement parameter of the object is determined based on the first holding position parameter and allows the operation items in the object to be displayed in a descending order of their priorities from the holding side to the opposite side on the display unit based on the order parameter. Here, the holding side is the side of the display unit closest to the operator. In this way, it is possible to allow the user to operate the object more convenient and the user convenience is thus improved.

Third, according to the embodiments of the present invention, when the input unit includes M physical input subunits, the correspondence parameter indicating a correspondence between the respective operation items and the M physical input subunits is determined based on the first holding position parameter. Accordingly, the display position of the object can be changed with an change in the first holding position parameter. In this way, both the user experience and the user convenience can be improved.

### BRIEF DESCRIPTION OF THE DRAWINGS

FIG. 1 is a flowchart illustrating a method for processing an object in an electronic device according an embodiment of the present application;

FIG. 2 is a flowchart illustrating a method for processing an object when the input unit includes a touch sensitive unit according an embodiment of the present application;

FIGS. 3A and 3B are diagrams showing that an operator types Chinese characters in Pinyin and English words, respectively, on a smart phone with both hands according to an embodiment of the present application;

FIGS. 4A and 4B are diagrams showing that an operator holds the smart phone shown in FIGS. 3A and 3B with one hand according to an embodiment of the present application, with the holding side being the side on which the character “EP” or the word “april” is first displayed as shown in FIGS. 3A and 3B;

FIG. 5 is a flowchart illustrating a method for processing an object when the input unit includes a number of physical input subunits according to an embodiment of the present application;

FIGS. 6A and 6B are diagrams showing that an operator operates a physical keyboard with both hands to input the Pinyin “shen” and English letters “app,” respectively, according to an embodiment of the present application;

FIGS. 7A and 7B are diagrams showing that an operator operates a physical keyboard with his/her right hand to input the Pinyin “shen” and English letters “app,” respectively, while the position of each operation item in the object is not changed according to an embodiment of the present application;

FIGS. 8A and 8B are diagrams showing that an operator operates a physical keyboard with his/her right hand to input the Pinyin “shen” and English letters “app,” respectively, while the position of each operation item in the object is not changed according to an embodiment of the present application; and

FIG. 9 is a block diagram of an electronic device according to an embodiment of the present application.

### DETAILED DESCRIPTION OF THE EMBODIMENTS

According to the embodiments of the present application, an electronic device and a method for processing an object are provided for solving the problem with the prior art that inconvenience and poor user experience occur when the user operates an electronic device with one hand, and thus provide improved user experience and user convenience.

In order to solve the above problem, some of the solutions according to the embodiments of the present application are as follows.

When a sensor unit detects that an operator is holding the electronic device, a first holding position parameter of the operator relative to an input unit is obtained. A correspondence between the object and the input unit is determined based on the first holding position parameter. The object is output by a display unit of the electronic device based on the correspondence.

As described above, after the first holding position parameter is obtained, a correspondence between the object and the input unit is determined based on the first holding position parameter. In this way, it is possible to adjust the correspondence between the object and the input unit as the holding position changes, such that the user can operate the object via the input unit in a more convenient manner, thereby improving user experience and user convenience.

For better understanding of the above technical solution, the above technical solutions will be detailed with reference to the figures and the embodiments.

According to the present application, a method for processing an object is provided. The method may be applied in an electronic device including a sensor unit, an input unit and a display unit. As shown in FIG. 1, the method includes the following steps.

At step S101, when the sensor unit detects that an operator is holding the electronic device, a first holding position parameter of the operator relative to the input unit is obtained.

In particular, when a user is using the electronic device, the user may operate the electronic device while holding or not holding it. The contact between the user and the electronic device may be determined by using the sensor unit to detect whether the operator is holding the electronic device. When the sensor unit detects that the operator is holding the electronic device, a first holding position parameter of the operator relative to the input unit is obtained based on the position on the electronic device at which the operator is holding the electronic device.

At step S102, a correspondence between the object and the input unit is determined based on the first holding position parameter.

In particular, after the first holding position parameter is obtained, a correspondence between the object and the input unit may be determined based on the first holding position parameter. The determination of the correspondence allows the user to use the electronic device in more convenient manner and the user convenience can thus be improved.

At step S103, the object is output by the display unit based on the correspondence.

In particular, after the correspondence between the object and the input unit and the object is determined, the correspondence may be established between the object and the input unit, and accordingly the object is output by the display unit of the electronic device.

According to the above solution, the correspondence between the object and the input unit is determined based on the first holding position parameter indicating the position where the operator is holding the electronic device, and the object is output by the display unit based on the correspondence. Thus, the user can use the electronic device in a more convenient manner. The correspondence between the object and the input unit may be the same or become different depending on different input units of the electronic device.

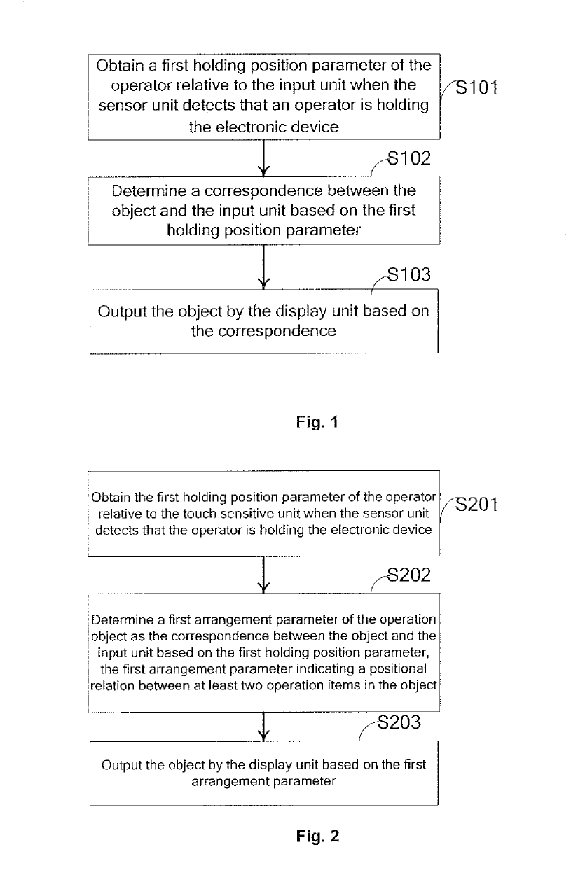

As shown in FIG. 2, when the input unit includes a touch sensitive unit, the method may include the following steps

At step S201, when the sensor unit detects that the operator is holding the electronic device, the first holding position parameter of the operator relative to the touch sensitive unit is obtained.

In particular, when the sensor unit detects that the operator is holding the electronic device, the first holding position parameter of the operator relative to the touch sensitive unit is obtained based on the position where the operator is holding the electronic device and the manner in which the operator is holding the electronic device.

The operator may not hold the electronic device when he/she initially operates the electronic device, and may hold up the electronic device after a period of operation. Thus, before the operator holds the electronic device, the object on the electronic device has been determined. As such, before obtaining the first holding position parameter, the object displayed on the display unit may be obtained. When the sensor unit detects that the operator is holding up the electronic device, the first holding position parameter of the operator relative to the touch sensitive unit is obtained. For example, the operator types the Pinyin of “ [symbol] ” PING, while the mobile phone lies on a table. In this case, the object displayed on the mobile phone includes operation items such as “ [symbol] ”, “ [symbol] ”, “ [symbol] ”, and “ [symbol] ” for selection by the user. As another example, the operator types English letters “app”, while the mobile phone lies on a table. In this case, the object displayed on the mobile phone includes operation items such as “apply”, “application”, “apple”, “appear” and “approach” for selection by the user. At this time, the operator needs to grasp the mobile phone for operation. That is, before the operator grasps the mobile phone, the object and its position on the electronic device have been determined.

At step S202, a first arrangement parameter of the object is determined as a correspondence between the object and the input unit based on the first holding position parameter. The first arrangement parameter indicates a positional relation between at least two operation items in the object.

In particular, after obtaining the first holding position parameter indicative of the position where the operator is holding the electronic device, it is judged whether the operator is operating the electronic device with one hand or both bands. The first arrangement parameter of the object can be determined base on the judgment result and the first holding position parameter. When the input unit includes a touch sensitive unit, the operation items in the object correspond to different touch areas on the touch sensitive unit. Determining the first arrangement parameter based on the first holding position parameter is to determine a correspondence between each operation item in the object and a touch area on the touch sensitive unit. Thus, the first arrangement parameter belongs to the correspondence between the object and the input unit. In an embodiment, before it is detected that the operator is holding the electronic device, the operator may have been operating the electronic device, and thus the object on the electronic device and each operation item in the object have been determined. After obtaining the first holding position parameter, it is judged based on the first holding position parameter whether the operator is operating the electronic device with one hand or both hands. When the operator is operating the electronic device with one hand, an order parameter for a priority of each operation item in the object is determined based on a predetermined policy. Then a display position where each operation item in the object is to be display on the display unit may be determined based on the order parameter and the first holding position parameter. Here, the predetermined policy may be based on historical information stored in the electronic device. The order parameter for the priority of each operation item in the object may be determined based on the historical information. For example, when a Pinyin “KAI” is typed on a smart phone, an order parameter for the priority of each Chinese character that is associated with the Pinyin “KAI” may be determined based on the historical information stored in the smart phone regarding, for example, the most commonly used characters, most frequently used characters or recently used characters among all the Chinese characters, such as “ [symbol] ”, “ [symbol] ”, “ [symbol] ”, “ [symbol] ” and “ [symbol] ”. This mechanism also applies to input of English words. For example, when English letters “app” are typed, the most commonly used, or most frequently used or recently used words that begin with the letters “app” are displayed on the phone.

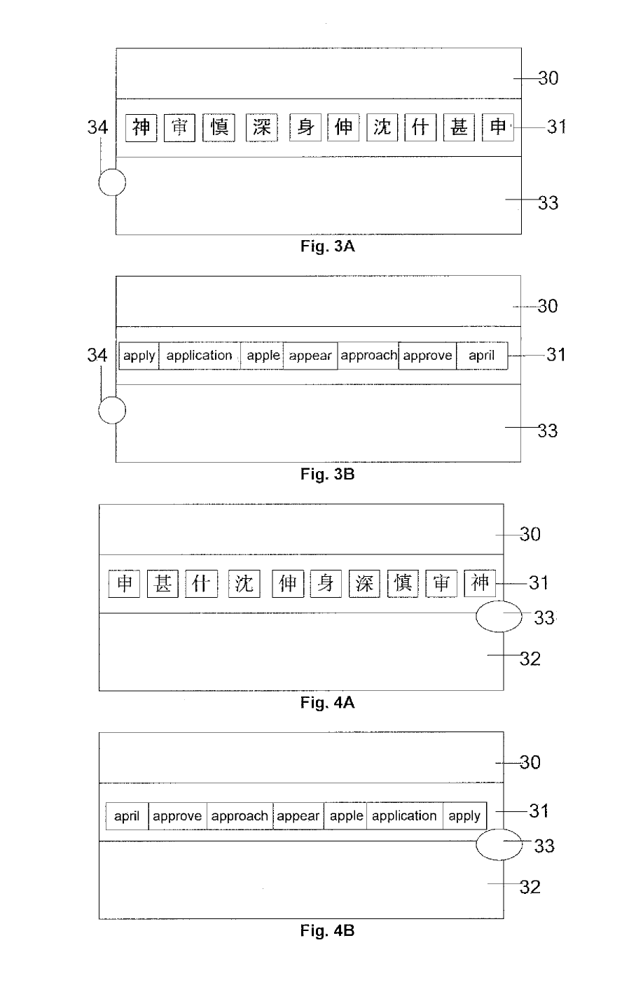

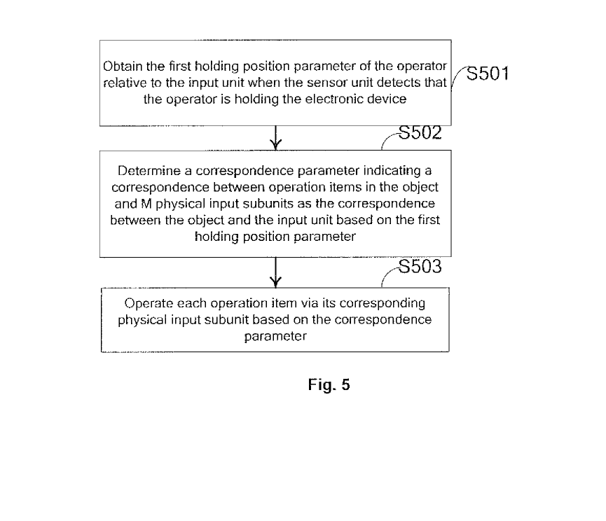

When determining the display position where each operation item in the object is to be displayed on the display unit based on the order parameter and the first holding position parameter, a side of the display unit closest to the operator is determined as a holding side based on the first holding position parameter. The operation items are displayed in a descending order of their priorities from the holding side to an opposite side of the display unit based on the order parameter. Currently, the display screen of a smart phone or a tablet computer may be designed to have a rectangular shape or a non-standard rectangular shape. For example, in order to provide a smart phone with more attractive aesthetic appearance, four angles of its rectangular display screen may be rounded or have some other shape. FIGS. 3A and 3B show respectively initial display screens when the operator types the Pinyin “shen” and the letters “app” on the smart phone with both hands or with his left hand holding the smart phone (i.e., holding the smart phone at position 34). As shown in FIGS. 3A and 3B, the upper area of the display screen presents a background 30 when the Pinyin “shen” or the letters “app” are typed. The background 30 may be one for sending a short message or online chatting (e.g., QQ chatting application). The object 31 is used to display the operation items included in the object 31, such as the most commonly used Chinese characters corresponding to the Pinyin “shen”, including “ [symbol] ”, “ [symbol] ”, “ [symbol] ” and “ [symbol] ”, or the most commonly used English words beginning with the letters “app,” such as “apply”, “application”, “apple”, “appear” and “approach”. A touch key display area 32 is also included. As shown in FIGS. 4A and 4B, the operator is holding the electronic device with one hand, and the holding position 33 is close to the side of the screen on which the character “ [symbol] ” or the word “april” is first displayed. In this case, the side close to the character “ [symbol] ” or the word “april” is determined as the holding side, and its opposite side is the side of the screen on which the character “ [symbol] ” or the word “apply” is first displayed. Based on the order parameter of these Chinese characters, the operation items are displayed in a descending order of their priorities from the holding side to its opposite side on the screen. That is, as shown in FIG. 4A, the character “ [symbol] ” or the word “apply” is displayed at the position where the character “ [symbol] ” or the word “april” was initially displayed, and the character “ [symbol] ” or the word “application” is displayed at the position where the character “ [symbol] ” or the word “approve” was initially displayed. As shown in FIG. 4B, the word “apply” is displayed at the position where the word “april” was initially displayed, and the word “application” is displayed at the position where the word “approve” was initially displayed. The other Chinese characters or the English words are displayed in such an order that the operation item having a higher priority is arranged closer to the holding side, i.e., closer to the operating position 33. In this way, the operator can operate the object in a more convenient manner and the user convenience is thus improved.

Further, if it is determined that the operator is holding the electronic device with both hands, the obtained first arrangement parameter may be the same as the initial arrangement parameter of the object. For example, FIGS. 3A and 3B show an initial arrangement on the smart phone. If it is detected that the user is operating the electronic device with both hands, the obtained first arrangement parameter of the object indicates the same arrangement as that of FIGS. 3A and 3B, since the operator is operating the electronic device with both hands and no inconvenience will occur during the operator's operation. Besides, the user is familiar with the arrangement of the object as shown in FIGS. 3A and 3B. Therefore, the initial arrangement of the object, as it is, will be represented by the first arrangement parameter of the object. In this way, there is no inconvenience for user's operation.

Further, when there is no operator's operation on the electronic device before it is detected that an operator is holding the electronic device, an operation instruction is obtained from the operator while obtaining the first holding position parameter. The object associated with the operation instruction is obtained based on the operation instruction. Then, the first arrangement parameter of the object is determined based on the first holding position parameter. As above, after obtaining the first holding position parameter, it is judged whether the operator is operating the electronic device with one hand or both bands. The first arrangement parameter of the object can be determined based on the judgment result and the first holding position parameter. When the operator is operating the electronic device with both hands, the arrangement of the object when the electronic device is not held by the operator may be directly used as the first arrangement parameter of the object as shown in FIGS. 3A and 3B. When the operator is operating the electronic device with one hand, the first arrangement parameter of the object is determined based on the first holding position parameter as shown in FIGS. 4A and 4B.

At step S203, the object is output by the display unit based on the first arrangement parameter.

In particular, after the first arrangement parameter is determined, the object is output by the display unit based on the first arrangement parameter, as shown in FIGS. 3A, 3B, 4A and 4B. When the operator is operating the electronic device with one hand, and the holding side is close to the character “ [symbol] ” or the word “april”, the is object is output on the display unit as shown in FIG. 4A or 4B. When the operator is operating the electronic device using both hands, the object is output on the display unit as shown in FIG. 3A or 3B. While the object is being displayed on the display unit, if it is detected that the first holding position parameter indicating the position where the operator is holding the electronic device changes, the steps S201 to S203 will be automatically executed. In this way, it is possible to facilitate the operator's operation.

Meanwhile, when the input unit includes a number M of physical input subunits, the method may include the following steps.

At step S501, when the sensor unit detects that the operator is holding the electronic device, the first holding position parameter of the operator relative to the input unit is obtained.

In particular, the input unit is a physical keyboard including M physical input subunits. When the operator is operating the electronic device via the physical keyboard, the first holding position parameter of the operator relative to the physical keyboard is obtained via the sensor unit.

At step S502, a correspondence parameter indicating a correspondence between operation items in the object and the M physical input subunits is determined as the correspondence between the object and the input unit based on the first holding position parameter.

In particular, after obtaining the first holding position parameter, it is judged whether the operator is operating the physical keyboard with one hand or both bands based on the first holding position parameter. Then, the correspondence parameter indicating a correspondence between the operation items in the object and the M physical input subunits is determined based on the judgment result and the first holding position parameter. When the operator is operating the physical keyboard with both hands, the correspondence between the physical input subunits and the operation items in the object is the initial correspondence between the input subunits and the object. For example, among the physical input subunits for typing a Chinese character having a Pinyin of “heng” via the keyboard, the numeric key “1” corresponds to a Chinese character “ [symbol] ”, and the numeric key “2” corresponds to a Chinese character “ [symbol] ”. When the physical keyboard is operated with both hands, the correspondence between the Chinese characters having the Pinyin of “heng” and the keys in the physical keyboard remains unchanged. When the operator is operating the physical keyboard with one hand, the correspondence between the operation items in the object and the M physical input subunits may change. In this case the correspondence between the operation items in the object and the M physical input subunits may be determined based on the first holding position parameter. For example, when the operator is operating the physical keyboard with his/her right hand to type the Pinyin “heng” via the keyboard, the Chinese character “ [symbol] ” having the Pinyin “heng” initially corresponds to the numeric key “1”. However, in order to allow the user to operate with his/her right hand conveniently, the Chinese character “ [symbol] ” now corresponds to the numeric key “0”, the Chinese character “ [symbol] ” corresponds to the numeric key “9”, and the correspondence for other characters remain unchanged. In this way, the operator can operate the object without his/her hand moving over a long distance with respect to the physical keyboard, and the user convenience is thus improved. As above, when the user is operating the physical keyboard with his/her left hand, the operation items corresponding to the numeric keys 6 to 9 correspond to the alphabetic keys near his/her left hand. For example, among the Chinese characters having the Pinyin “heng”, the character “ [symbol] ” corresponds to the numeric key “6”, the character “ [symbol] ” corresponds to the numeric key “7”, the character “ [symbol] ” corresponds to the numeric key “8” and the character “ [symbol] ” corresponds to the numeric key “9”. Since the physical keyboard is operated with the left hand, the character “ [symbol] ” corresponds to the alphabetic key “q” in the physical keyboard, the character “ [symbol] ” corresponds to the alphabetic key “w” in the physical keyboard, the character “ [symbol] ” corresponds to the alphabetic key “e” in the physical keyboard, the character “ [symbol] ” corresponds to the alphabetic key “r” in the physical keyboard. In this way, the distance the operator's hand needs to move over the physical keyboard can be reduced, and the user convenience is thus improved.

The above mechanism is also applicable to input of English words, which will be explained in the following examples.

When the input unit includes M physical input subunits, different operation items in the object may correspond to different ones of the M physical input subunits. When determining the correspondence parameter indicating the correspondence between operation items in the object and the M physical input subunits based on the first holding position parameter, the different operation items in the object may correspond to different ones of the M physical input subunits. The correspondence parameter indicating the correspondence between operation items in the object and the M physical input subunits belongs to the correspondence between the object and the input unit.

At step S503, each operation item in the object is operated via its corresponding physical input subunit based on the correspondence parameter.

In particular, each operation item in the object corresponds to a physical input subunit according to the correspondence parameter obtained in the step S502, such that an operation item can be operated via its corresponding physical input subunit.

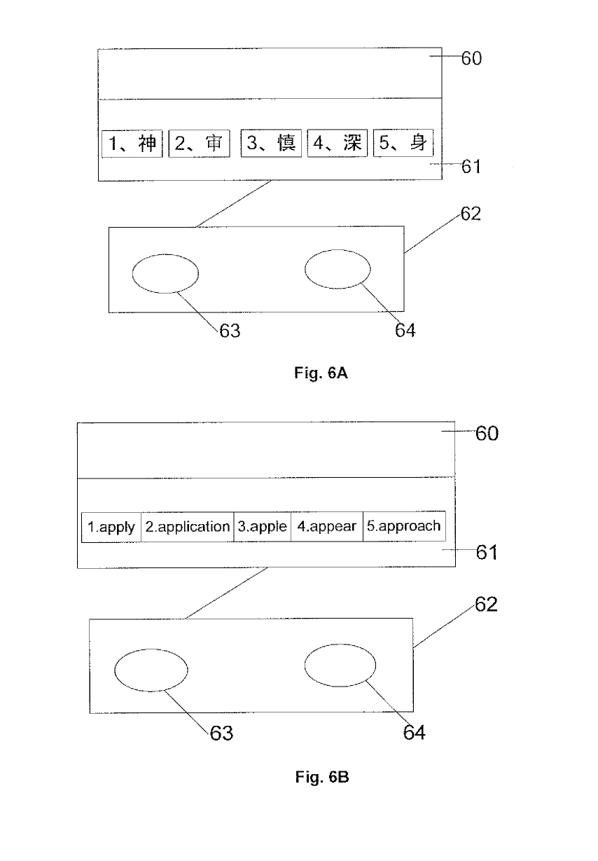

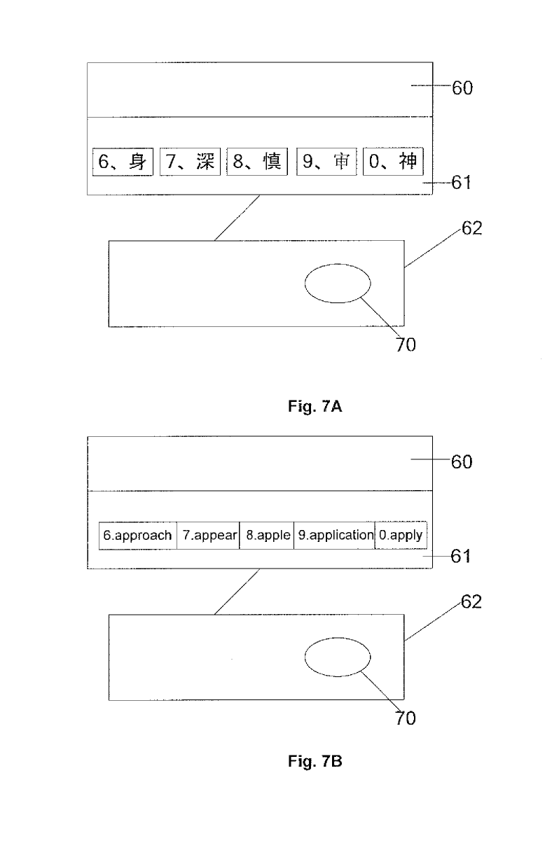

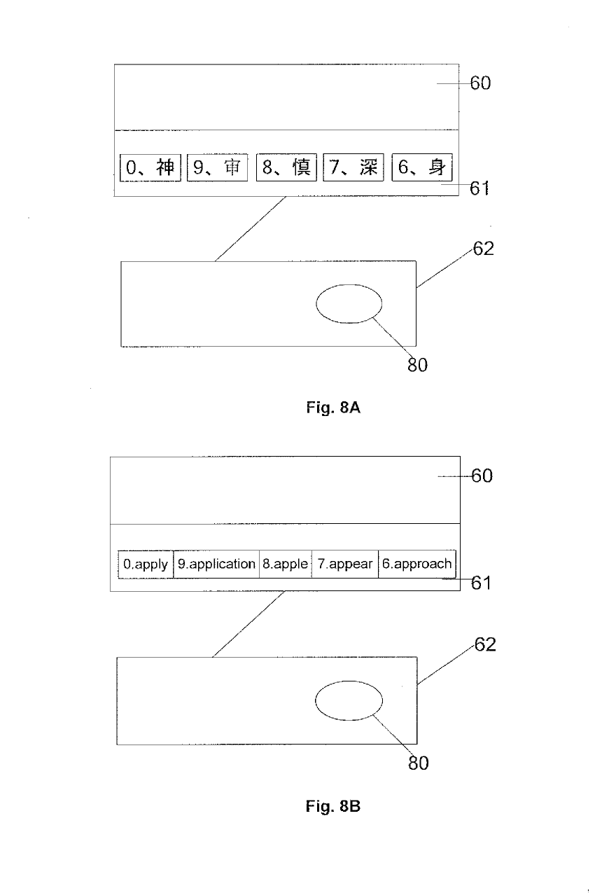

In an embodiment, after determining the correspondence parameter indicating the correspondence between operation items in the object and the M physical input subunits, a first display position for each operation item in the object on the display unit may be determined. Then a second display position for each operation item in the object may be determined based on the first holding position parameter. The second display position may be the same as or different from the first display position. Each operation item in the object is then displayed on its second display position based on the correspondence parameter and the second display position, such that it corresponds to its corresponding physical input subunits. When the operator is operating the physical keyboard with both hands, the correspondence parameter indicating the correspondence between the physical keyboard and each operation item in the object may remain unchanged. In this case, the first display position of each operation item in the object is the same as its second display position. When the operator is operating the physical keyboard with one hand, each operation item in the object is displayed at its second display position on the display unit, and the second display position may different from the second display position. For example, as shown in FIGS. 6A and 6B, the screen of the computer includes a background 60 in the upper area of the screen and an object 61 in the lower area of the screen. A physical keyboard 62 is connected to the display screen. When the physical keyboard 62 is operated with both hands (with a left hand holding position 63 and a right hand holding position 64), the numeric key “1” corresponds to the Chinese character “ [symbol] ” or the English word “apply”, the numeric key “2” corresponds to the Chinese character “ [symbol] ” or the English word “application”, the numeric key “3” corresponds to the Chinese character “ [symbol] ” or the English word “apple”, the numeric key “4” corresponds to the Chinese character “ [symbol] ” or the English word “appear”, and the numeric key “5” corresponds to the Chinese character “ [symbol] ” or the English word “approach”. As shown in FIGS. 7A and 7B, when the operator is operating the electronic device with his/her right hand at a holding position 70, the numeric key “0” corresponds to the Chinese character “ [symbol] ” or the English word “apply”, the numeric key “9” corresponds to the Chinese character “ [symbol] ” or the English word “application”, the numeric key “8” corresponds to the Chinese character “ [symbol] ” or the English word “apple”, the numeric key “7” corresponds to the Chinese character “ [symbol] ” or the English word “appear”, and the numeric key “6” corresponds to the Chinese character “ [symbol] ” or the English word “approach”. The second display position of the Chinese character “ [symbol] ” or the English word “apply” becomes the same as the display position of the Chinese character “ [symbol] ” or the English word “approach” in FIG. 6A or 6B, the second display position of the Chinese character “ [symbol] ” or the English word “application” becomes the same as the display position of the Chinese character “ [symbol] ” or the English word “appear” in FIG. 6A or 6B, and the display positions of other Chinese characters and English words in FIGS. 7A and 7B are also changed accordingly. As shown in FIGS. 8A and 8B, the operator is operating the electronic device with his/her right hand, and the holding position 80 of the operator is the same as the holding position 70. The correspondence between the Chinese characters or the English words and the numeric keys of the physical keyboard 63 is the same as that shown in FIG. 7A or 7B, except that the display positions of the Chinese characters or the English words remain unchanged (i.e., the display position of the Chinese character “ [symbol] ” or the English word “apply” is the same as that shown in FIG. 6A or 6B). The display positions of other Chinese characters or the English words are the same as those in FIG. 6A or 6B. In the prior art, when characters are being typed in various desktop computers or notebook computers, common characters are all arranged from left to right and correspond to the numeric keys 1 to 9 on the physical keyboard. When the user is operating a desktop or notebook computer with his/her right hand, the user has to move his/her hand for a long distance over the keyboard to reach a key on the left side of the physical keyboard which corresponds to the most common character. The embodiment of the present application eliminates the long-distance movement and thus provides improved user convenience.

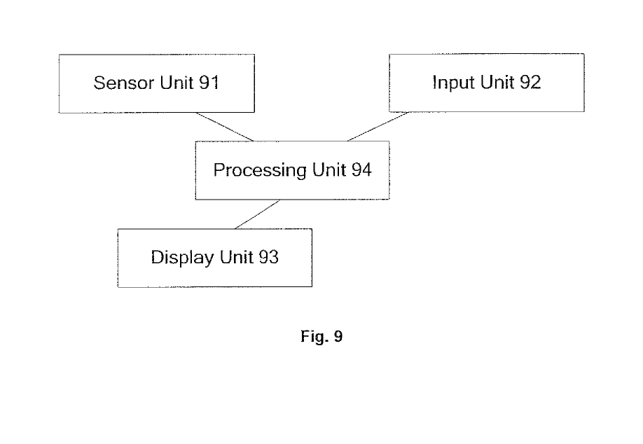

An electronic device is also provided. The electronic device includes a sensor unit 91, an input unit 92 and a display unit 93. As shown in FIG. 9, the electronic device includes a processing unit 94 configured to, when the sensor unit 91 detects that an operator is holding the electronic device, obtain a first holding position parameter of the operator relative to the input unit 92, determine a correspondence between the object and the input unit 92 based on the first holding position parameter, and output the object via the display unit 93 based on the correspondence.

When the input unit 92 includes a touch sensitive unit, the processing unit 94 is further configured to when the sensor unit 91 detects that the operator is holding the electronic device, obtain the first holding position parameter of the operator relative to the touch sensitive unit, determine a first arrangement parameter of the object as a correspondence between the object and the input unit 92 based on the first holding position parameter, the first arrangement parameter indicating a positional relation between at least two operation items in the object, and output the object via the display unit 93 based on the first arrangement parameter.

The processing unit further includes an arrangement parameter obtaining unit configured to determine an order parameter for a priority of each operation item in the object based on a predetermined policy, and determine a display position where each operation item is to be displayed on the display unit 93 based on the order parameter and the first holding position parameter.

The arrangement parameter obtaining unit further includes a display position obtaining subunit configured to determine a side of the display unit 93 closest to the operator as a holding side based on the first holding position parameter, and display the operation items in the object in a descending order of their priorities from the holding side to an opposite side on the display unit 93 based on the order parameter.

When the sensor unit 91 detects that an operator is holding the electronic device, the processing unit 94 is further configured to obtain the object displayed on the display unit before obtaining the first holding position parameter, when the sensor unit detects that the operator is holding the electronic device, obtain the first holding position parameter of the operator relative to the input unit 92, determine the first arrangement parameter of the object based on the first holding position parameter, and output the object via the display unit 93 based on the first arrangement parameter.

The processing unit 94 is further configured to obtain an operation instruction from the operator upon obtaining the first holding position parameter, obtain an object associated with the operation instruction based on the operation instruction, determine the first arrangement parameter of the object based on the first holding position parameter, and output the object via the display unit 93 based on the first arrangement parameter.

When the input unit 92 includes M physical input subunits, the processing unit 94 may be further configured to when the sensor unit 91 detects that the operator is holding the electronic device, obtain the first holding position parameter of the operator relative to the input unit 92, determine a correspondence parameter indicating a correspondence between operation items in the object and the M physical input subunits as the correspondence between the object and the input unit 92 based on the first holding position parameter, and operate each operation item in the object via a corresponding one of the physical input subunits based on the correspondence parameter.

The processing unit 94 is further configured to, after determining the correspondence parameter indicating the correspondence between operation items in the object and the M physical input subunits as the correspondence between the object and the input unit 92 based on the first holding position parameter, obtain a first display position where each operation item in the object is displayed on the display unit 93, determine a second display position for each operation item in the object based on the first holding position parameter, the second display position being the same as or different from the first display position, display each operation item on its second display position based on the correspondence parameter and the second display position, such that it corresponds to its corresponding physical input subunits.

The above technical solutions according to the embodiments of the present application have at least the following technical effects or advantages.

First, according to the embodiments of the present invention, a first holding position parameter of the operator relative to the input unit is obtained, a correspondence between the object and the input unit is determined based on the first holding position parameter, and the object is output by the display unit based on the correspondence. In this way, the object can be changed as the first holding position parameter changes, and thus both the user experience and the user convenience can be improved.

Second, according to the embodiments of the present invention, when the input unit includes a touch sensitive unit, the first arrangement parameter of the object is determined based on the first holding position parameter and allows the operation items in the object to be displayed in a descending order of their priorities from the holding side to the opposite side on the display unit based on the order parameter. Here, the holding side is the side of the display unit closest to the operator. In this way, it is possible to allow the user to operate the object more convenient and the user convenience is thus improved.

Third, according to the embodiments of the present invention, when the input unit includes M physical input subunits, the correspondence parameter indicating a correspondence between the respective operation items and the M physical input subunits is determined based on the first holding position parameter. Accordingly, the display position of the object can be changed as the first holding position parameter changes. In this way, both the user experience and the user convenience can be improved.

While the present invention has been described with reference to the above embodiments, various modifications and alternatives can be made to these embodiments by those skilled in the art without departing from the gist of the present invention. The claims as attached are to be interpreted as covering the above embodiments and all the modifications and alternatives within the scope of the present invention.

Various modifications and alternatives can be made to the present invention without departing from the spirit and scope of the present invention. Thus, if such modifications and alternatives are covered by claims as attached and the equivalents thereof, these modifications and alternatives are to be encompassed by the scope of the present invention.

What is claimed is:

1. A method for processing an object in an electronic device comprising a sensor unit, an input unit and a display unit, the method comprising:
obtaining a first holding position parameter of the operator relative to the input unit when the sensor unit detects that an operator is holding the electronic device;
determining a correspondence between the object and the input unit based on the first holding position parameter; and
outputting the object by the display unit based on the correspondence.

2. The method of claim 1, wherein the input unit comprises a touch sensitive unit, and the method further comprises:
obtaining the first holding position parameter of the operator relative to the touch sensitive unit, when the sensor unit detects that the operator is holding the electronic device;
determining a first arrangement parameter of the object as the correspondence between the object and the input unit based on the first holding position parameter, the first arrangement parameter indicating a positional relation between at least two operation items in the object; and
outputting the object by the display unit based on the first arrangement parameter.

3. The method of claim 2, wherein determining a first arrangement parameter of the object as the correspondence between the object and the input unit based on the first holding position parameter further comprises:
determining an order parameter for a priority of each of the operation items in the object based on a predetermined policy; and
determining a display position for each of the operation items on the display unit based on the order parameter and the first holding position parameter.

4. The method of claim 3, wherein determining the display position for each of the operation items on the display unit based on the order parameter and the first holding position parameter comprises:
determining a side of the display unit closest to the operator as a holding side based on the first holding position parameter; and
displaying the operation items in a descending order of their priorities from the holding side to an opposite side on the display unit based on the order parameter.

5. The method of claim 2, further comprising, when the sensor unit detects that an operator is holding the electronic device:
obtaining the object displayed on the display unit before obtaining the first holding position parameter;
obtaining the first holding position parameter of the operator relative to the input unit when the sensor unit detects that the operator is holding the electronic device;
determining the first arrangement parameter of the object based on the first holding position parameter; and
outputting the object by the display unit based on the first arrangement parameter.

6. The method of claim 2, wherein determining a first arrangement parameter of the object as the correspondence between the object and the input unit based on the first holding position parameter further comprises:
obtaining an operation instruction from the operator while obtaining the first holding position parameter;
obtaining an object associated with the operation instruction based on the operation instruction;
determining the first arrangement parameter of the object based on the first holding position parameter; and
outputting the object by the display unit based on the first arrangement parameter.

7. The method of claim 1, wherein the input unit comprises M physical input subunits, and the method further comprises:
obtaining the first holding position parameter of the operator relative to the input unit when the sensor unit detects that the operator is holding the electronic device;
determining a correspondence parameter indicating a correspondence between operation items in the object and the M physical input subunits as the correspondence between the object and the input unit based on the first holding position parameter; and
operating each of the operation item via a corresponding one of the physical input subunits based on the correspondence parameter.

8. The method of claim 7, further comprising, after determining the correspondence parameter indicating a correspondence between operation items in the object and the M physical input subunits as the correspondence between the object and the input unit based on the first holding position parameter:
obtaining a first display position for each of the operation items on the display unit;
determining a second display position for each of the operation items based on the first holding position parameter, the second display position being the same as or different from the first display position;
displaying each of the operation items at its second display position based on the correspondence parameter and the second display position, such that the operation item corresponds to its corresponding physical input subunits.

9. An electronic device comprising a sensor unit, an input unit and a display unit, wherein the electronic device further comprising:
a processing unit configured to
obtain a first holding position parameter of the operator relative to the input unit, when the sensor unit detects that an operator is holding the electronic device;
determine a correspondence between the object and the input unit based on the first holding position parameter; and
output the object via the display unit based on the correspondence.

10. The electronic device of claim 9, wherein the input unit comprises a touch sensitive unit, and the processing unit is further configured to:
obtain the first holding position parameter of the operator relative to the touch sensitive unit when the sensor unit detects that the operator is holding the electronic device;
determine a first arrangement parameter of the object as the correspondence between the object and the input unit based on the first holding position parameter, the first arrangement parameter indicating a positional relation between at least two operation items in the object; and
output the object via the display unit based on the first arrangement parameter.

11. The electronic device of claim 10, wherein the processing unit comprises an arrangement parameter obtaining unit configured to:
determine an order parameter for a priority of each of the operation items in the object based on a predetermined policy; and
determine a display position for each of the operation items on the display unit based on the order parameter and the first holding position parameter.

12. The electronic device of claim 11, wherein the arrangement parameter obtaining unit comprises a display position obtaining subunit configured to:
determine a side of the display unit closest to the operator as a holding side based on the first holding position parameter; and
display the operation items in a descending order of their priorities from the holding side to an opposite side on the display unit based on the order parameter.

13. The electronic of claim 10, wherein when the sensor unit detects that an operator is holding the electronic device, the processing unit is further configured to:
obtain the object displayed on the display unit before obtaining the first holding position parameter;
obtain the first holding position parameter of the operator relative to the input unit when the sensor unit detects that the operator is holding the electronic device;
determine the first arrangement parameter of the object based on the first holding position parameter; and
output the object via the display unit based on the first arrangement parameter.

14. The electronic device of claim 10, wherein the processing unit is further configured to:
obtain an operation instruction from the operator upon obtaining the first holding position parameter;
obtain an object associated with the operation instruction based on the operation instruction;
determine the first arrangement parameter of the object based on the first holding position parameter; and
output the object via the display unit based on the first arrangement parameter.

15. The electronic device of claim 9, wherein the input unit comprises M physical input subunits, and the processing unit is further configured to:
obtain the first holding position parameter of the operator relative to the input unit when the sensor unit detects that the operator is holding the electronic device;
determine a correspondence parameter indicating a correspondence between operation items in the object and the M physical input subunits as the correspondence between the object and the input unit based on the first holding position parameter; and
operate each of the operation items via a corresponding one of the physical input subunits based on the correspondence parameter.

16. The electronic device of claim 15, wherein the processing unit is further configured to, after determining the correspondence parameter indicating the correspondence between operation items in the object and the M physical input subunits as the correspondence between the object and the input unit based on the first holding position parameter,
obtain a first display position for each of the operation items on the display unit;
determine a second display position for each of the operation items based on the first holding position parameter, the second display position being the same as or different from the first display position;
display each of the operation items at its second display position based on the correspondence parameter and the second display position, such that the operation items corresponds to its corresponding physical input subunits.
